(19) United States
(12) Patent Application Publication
(10) Pub. No.: US 2023/0298551 A1
(43) Pub. Date: Sep. 21, 2023

(54) MANIPULATOR FOR ELECTRONIC MUSICAL INSTRUMENTS

(71) Applicant: CASIO COMPUTER CO., LTD., Tokyo (JP)

(72) Inventor: Otoya Sakai, Tokyo (JP)

(73) Assignee: CASIO COMPUTER CO., LTD., Tokyo (JP)

(21) Appl. No.: 18/183,686

(22) Filed: Mar. 14, 2023

(30) Foreign Application Priority Data
Mar. 15, 2022 (JP) 2022-039931

(51) Int. Cl. G10H 1/34; G05G 1/10

(52) U.S. Cl. CPC G10H 1/34; G05G 1/10; G10H 2210/225

(57) ABSTRACT

A manipulator includes a case; an axis-having member having a rotatable member; an operation member attached to the rotatable member of the axis-having member so as to be rotatable together with the rotatable member; and a fixing member that fixes the axis-having member to the case, the fixing member having a flexible member that is attached to the axis-having member.

### BACKGROUND OF THE INVENTION

### Technical Field

The present invention relates to a manipulator for performance control in electronic musical instruments and electronic musical instruments.

### Background Art

Conventionally, electronic musical instruments such as electronic pianos are known to have a manipulator for imparting performance effects such as pitch bend to musical tones in which the manipulator is installed in the electronic musical instrument through a fixing member.

For example, Japanese Patent Application Laid-Open No. H11-249655 discloses an electronic keyboard instrument provided with a multi-function operation wheel (operator) having a rotary variable resistor. In this electronic keyboard instrument, the variable resistor of the multifunction operation wheel is fixed to a part of the case of the electronic keyboard instrument via a bracket.

### SUMMARY OF THE INVENTION

Features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a manipulator, comprising: a case; an axis-having member having a rotatable member; an operation member attached to the rotatable member of the axis-having member so as to be rotatable together with the rotatable member; and a fixing member that fixes the axis-having member to the case, the fixing member having a flexible member that is attached to the axis-having member.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is an overall perspective view of an electronic keyboard instrument according to an embodiment.

FIG. 2 is a perspective view of a left case of the electronic keyboard instrument according to the embodiment, viewed from the upper right side.

FIG. 3 is a perspective view of the left case of the electronic keyboard instrument according to the embodiment as seen from the lower right side.

FIG. 4 is a perspective view of a pitch bender according to the embodiment as seen from the front right side.

FIG. 5 is a perspective view of the pitch bender according to the embodiment as seen from the front left side.

FIG. 6 is an exploded perspective view of the pitch bender according to the embodiment.

FIG. 7 is a side view of an operation wheel of the pitch bender according to the embodiment as seen from the right side, and is a side view showing the manner of rotation of the operation wheel.

FIG. 8 is a cross-sectional view of the pitch bender according to the embodiment, which is a cross-sectional view of the VIII-VIII cross section in FIG. 2.

FIG. 9 is a cross-sectional view of the pitch bender according to the embodiment, and is a cross-sectional view showing a state when a rightward load is applied to the operation wheel in the cross section corresponding to FIG. 8.

FIG. 10 is a cross-sectional view of the pitch bender according to the embodiment, showing a state when a leftward or downward load is applied to the operation wheel in the cross section corresponding to FIG. 8.

### DETAILED DESCRIPTION OF EMBODIMENTS

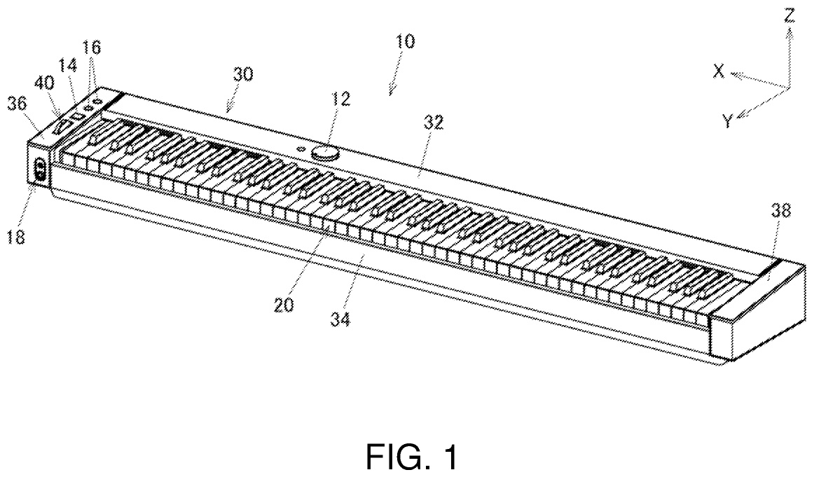

An embodiment of the present invention will be described with reference to the drawings. An electronic keyboard instrument (electronic musical instrument) 10 shown in FIG. 1 includes a keyboard 20 having a plurality of white keys and a plurality of black keys, and a case 30. A control board and the like are accommodated inside the case 30.

Each figure shows coordinate axes; the X-axis direction in each figure is the left-right direction of the electronic keyboard instrument 10 (the positive direction of the X-axis is the left direction); the Y-axis direction in each figure is the front-rear direction of the keyboard instrument 10 (the positive direction of the Y-axis is defined as the front direction); and the Z-axis direction in each figure is the vertical direction of the electronic keyboard instrument 10 (the positive direction of the Z-axis is defined as the upward direction).

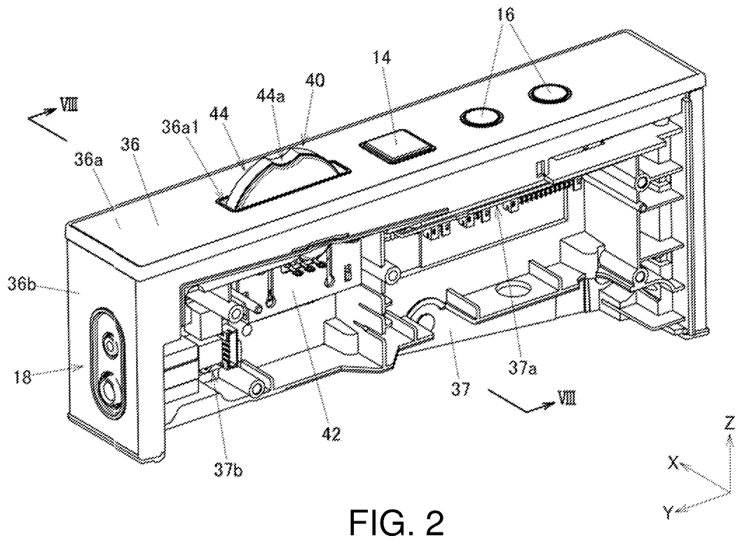

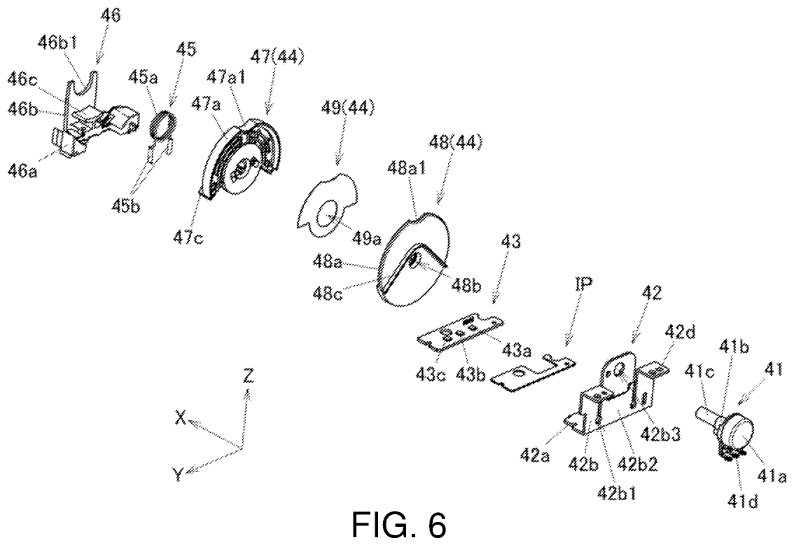

The case 30 has a horizontally long rectangular shape with the left-right direction as the longitudinal direction, is made of synthetic resin, and is divided into an upper case 32, a lower case 34, a left case 36, and a right case 38. A part of the upper surface of the upper case 32 is provided with a dial 12 for controlling the volume of musical tones. As shown in FIG. 2, the left case 36 has a top panel (“panel member”) 36a forming its upper surface and a case side wall 36b forming its side wall. The front portion of the top panel 36a is provided with an operation opening 36a1 through which a portion of a pitch bender (manipulator) 40 (an operation wheel 44, which will be described later) is exposed for imparting pitch bend to musical tones and controlling the pitch bend. On the rear side of the top panel 36a, there are provided a light emission button 14 for starting or stopping the emission of each of the LEDs 43a to 43c (see FIG. 6, etc.) provided in the pitch bender 40, and setting buttons 16 for various settings. An earphone jack 18 is provided on the front surface of the case side wall 36b.

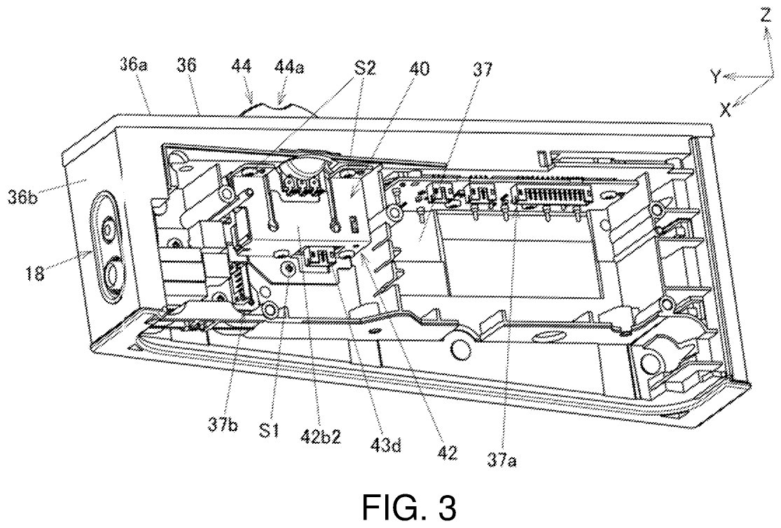

An internal frame (frame member) 37 that is a frame-shaped member is provided on the inner surface side of the left case 36. Inside the internal frame 37, a first substrate 37a for accepting pressing operations of the light emission button 14 and the setting buttons 16, a second substrate 37b for accepting insertion/removal operations of the earphone jack 18, a pitch bender 40, and the like are attached. The pitch bender 40 is housed inside the left case 36 with a part thereof exposed from the operation opening 36a1, and is fixed inside the inner frame 37 by the first fixing screw 51 and the second fixing screws S2 (see FIG. 3). The first substrate 37a and the second substrate 37b and the first substrate 37a and the pitch bender 40 are electrically connected by connection wirings (not shown). Also, the first substrate 37a and the second substrate 37b are electrically connected to the control board of the electronic keyboard instrument 10 by connection wirings (not shown).

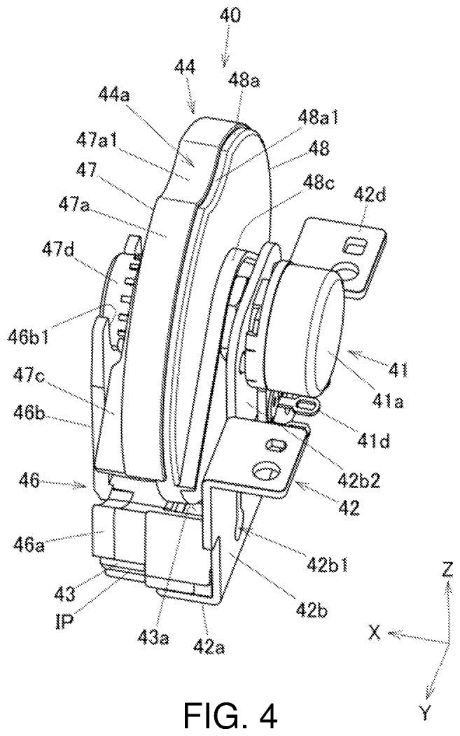

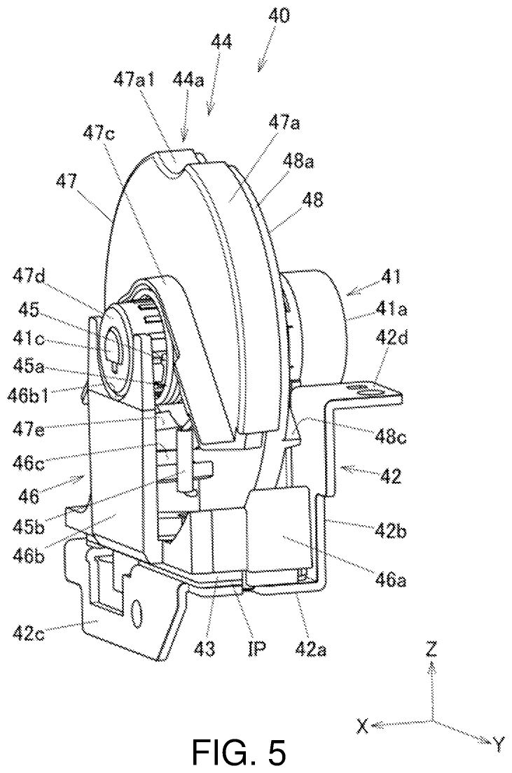

The configuration of the pitch bender 40 will be explained in detail. As shown in FIGS. 4 to 6, the pitch bender 40 includes a variable resistor (“an axis-having member having a rotatable member”) 41, a fixing metal fitting (“a fixing member”) 42, a light source substrate 43, an operation wheel (“an operation member”) 44, a torsion spring 45, and a holding member 46. The operation wheel 44 has a substantially disk shape, and has a wheel member 47, a light guide member 48, and a double-sided adhesive tape 49 for adhering the wheel member 47 and the light guide member 48 together (see FIG. 5). The upper portion of the operation wheel 44 is exposed through the operation opening 36a1 of the left case 36.

The variable resistor 41 is a rotatable rotary-type variable resistor, and includes a sensor front portion 41a, a sensor rear portion 41b, a shaft-shaped member 41c, and three wiring connection parts 41d extending from the lower side of the sensor front portion 41a. The sensor front portion 41a has a substantially circular columnar shape, and the sensor rear portion 41b has a substantially cylindrical shape that is narrower than the sensor front portion 41a and protrudes leftward from the left side of the sensor front portion 41a. The sensor front portion 41a and the sensor rear portion 41b constitute a rotation angle sensor.

The shaft-shaped member 41c extends axially along the left-right direction, and the right end thereof is inserted into the cylindrical inner side of the sensor rear portion 41b so as to be rotatable around the axis. The shaft-shaped member 41c has a substantially half-moon cross section at a portion exposed from the sensor rear portion 41b except for the vicinity of the boundary portion with the sensor rear portion 41b. A connection wiring connected to the first substrate 37a is connected to each of the wiring connection parts 41d. The variable resistor 41 detects the rotation angle of the shaft-shaped member 41c from the resistance value that changes according to the rotation of the shaft-shaped member 41c with respect to the sensor front portion 41a and the sensor rear portion 41b, converts the rotation angle into an electric signal, and outputs the electrical signal to the first substrate 37a through the connection wirings.

The fixing metal fitting 42 is a metal fitting for fixing respective members constituting the pitch bender 40 to each other and for fixing the pitch bender 40 to the inner frame 37, and has a substantially L-shaped cross section. The fixing metal fitting 42 includes a flat plate portion 42a arranged with its plate surfaces facing in the vertical directions, and a standing wall 42b rising from the right end of the flat plate portion 42a in a flat plate shape with its plate surfaces facing in the horizontal directions. The fixing metal fitting 42 includes a first screwing portion 42c having a threaded hole and extending downward from a part of the left end portion of the flat plate portion 42a, and second screwing portions 42d each having a threaded hole extending rightward from respective front and rear ends of the rising tip portion of the standing wall portion 42b.

The first screwing portion 42c abuts against the inner side surface of the inner frame 37, and the first fixing screw 51 is inserted through the screw hole along the left-right direction. The second screwing portion 42d abuts against the inner upper surface of the inner frame 37, and the second fixing screw S2 is vertically inserted into the screw hole of the second screwing portions 42d. In this manner, the fixing metal fitting 42 is firmly fixed to the inner frame 37 by screwing the first screwing portion 42c and the second screwing portions 42d to the inner side of the inner frame 37 with the first fixing screw 51 and the second fixing screws S2, respectively.

A pair of slits 42b1 that are open upward (in the direction perpendicular to the axial direction of the shaft-shaped member 41c) and extend in the vertical direction are provided at respective inner sides of the vertical wall portion 42b from which the two second screwing portions 42d extend up to the respective positions adjacent to the flat portion 42a. At the inner sides relative to the two slits 42b1, a plate-shaped resistor fixing portion (“flexible member”) 42b2 is provided, extending upward from the height position of the two second screwing portions 42d. In other words, a pair of slits 42b1 are provided on both front and rear sides of the resistor fixing portion 42b2.

In the resistor fixing portion 42b2, a circular opening 42b3, through which the sensor rear portion 41b of the variable resistor 41 is inserted, is formed in a portion positioned above the two second screwing portions 42d. The variable resistor 41 is coupled to the resistor fixing portion 42b2 by bolting with the sensor rear portion 41b inserted into the fixing opening 42b3. With the slits 42b1 provided on both sides of the resistor fixing portion 42b2, the resistor fixing portion 42b2 is more flexible than other parts of the fixing metal fitting 42 in a horizontal direction (i.e., the direction of the axis of the shaft-shaped member 41c) in a state where the fixing metal fitting 42 is fixed to the inner frame 37.

The light source substrate 43 is a flat printed circuit board arranged with its flat surfaces facing up and down. The light source substrate 43 is placed on the flat portion 42a of the fixing metal fitting 42 and fixed to the flat plate portion 42a by screwing. The light source substrate 43 is provided thereon with three LEDs (light source units) 43a, 43b, and 43c that emit light of different wavelength bands. The LEDs 43a to 43c are linearly arranged at regular intervals along the front-rear direction, and emit light upward from the light source substrate 43. A substantially rectangular parallelepiped light source connector 43d is provided on the lower surface of the light source substrate 43 (see FIG. 3). A connection wiring extending from the first substrate 37a side is connected to the light source connector 43d. An insulating plate IP is sandwiched between the flat plate portion 42a of the fixing metal fitting 42 and the light source substrate 43 to insulate them from each other.

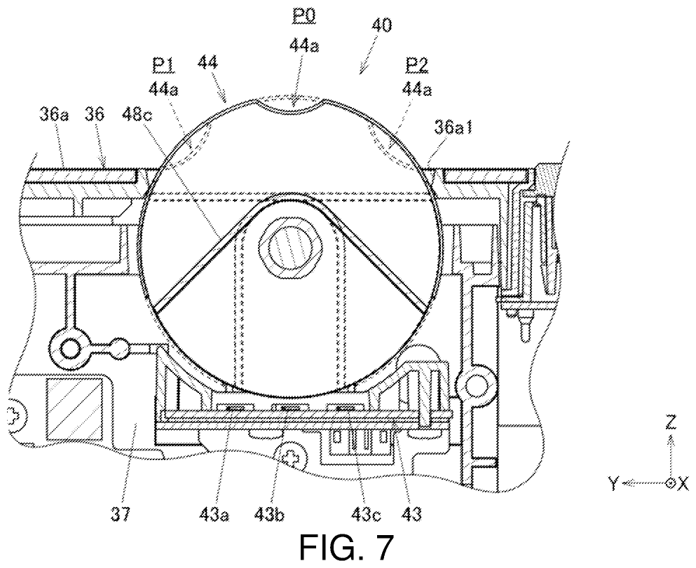

The operation wheel 44 is attached to the shaft-shaped member 41c of the variable resistor 41, and rotates together with the shaft-shaped member 41c around the axis of the shaft-shaped member 41c. A portion of the upper surface of the operation wheel 44 is provided with an operation recess 44a that is recessed in a substantially arc shape. The operation recess 44a is exposed from the operation opening 36a1 of the left case 36, and is provided so that the operator can easily rotate the operation wheel 44 by placing a finger or the like thereon. As shown in FIG. 7, the operation wheel 44 has an initial state PO in which the operation recess 44a is directed vertically upward, and is rotatable between a first state P1 that is rotated from the initial state PO towards the front side by 45 degrees around the axis of the shaft-shaped member 41c and a second state P2 that is rotated towards the rear side by 45 degrees.

The wheel member 47 of the operation wheel 44 is made of synthetic resin, and is a generally fan-shaped plate-like member in which about ¼ of a circle is missing at the lower portion. An outer wall portion 47a that slightly extends rightward in the form of a wall is provided on the edge of the wheel member 47 except for the lower portion (see FIG. 5). A wheel-side recessed portion 47a1, which is recessed in an arc shape and constitutes a part of the operation recess 44a, is provided in the central portion, in the front-rear direction, of the upper portion of the outer wall portion 47a. A wheel-side through hole 47b extending in the left-right direction is provided in the substantially central portion of the wheel member 47 in a substantially half-moon shape corresponding to the cross-sectional shape of the shaft-shaped member 41c. The wheel member 47 is fixed to the shaft-shaped member 41c by inserting the shaft-shaped member 41c into the wheel-side through hole 47b.

In addition, around the wheel-side through hole 47b on the left plate surface of the wheel member 47, a wheel-side projecting portion 47c projecting leftward is provided. The wheel-side projecting portion 47c is provided in a substantially L shape when viewed from the left side so that the wheel-side through hole 47b is hidden when the wheel member 47 is viewed from above. A left plate surface of the wheel member 47 is provided with a spring fixing portion 47d projecting leftward in a substantially cylindrical shape (see FIG. 5). The wheel-side through hole 47b described above is provided so as to pass through the inside of the spring fixing portion 47d. Below the spring fixing portion 47d, a first spring abutting portion 47e is provided that protrudes leftward in a substantially flat plate shape with its plate surfaces facing generally vertically. The plate surface of the first spring contact portion 47e is gently curved so as to be convex downward.

The light guide member 48 of the operation wheel 44 has a substantially disc shape and is made of a material with excellent transmittance (for example, acrylic resin). As shown in FIG. 7, the light guide member 48 is arranged above the light source substrate 43 with slight gaps with the LEDs 43a to 43c so as to guide light emitted from LEDs 43a to 43c upwards. The left plate surface of the light guide member 48 is attached to the plate surface located inside the outer wall portion 47a of the wheel member 47 via a double-sided adhesive tape 49, and rotates together with the wheel member 47 around the axis of the shaft-shaped member 41c. A tape-side through hole 49a through which the shaft-shaped member 41c is inserted is provided in a substantially central portion of the double-sided tape 49. Thus, the wheel member 47 is arranged on a one side of the plate surface of the light guide member 48 and supports the light guide member 48.

In the end edge 48a of the light guide member 48, at the center of the upper portion in the front-rear direction, a light guide side recess 48a1 that is recessed in a substantially arc shape in substantially the same shape as the wheel side recess 47a1 and that constitutes a part of the operation recess 44a is provided. A light guide-side through hole 48b penetrating in the left-right direction is provided at substantially the center of the side surface of the light guide member 48. The light guide member 48 has the shaft-shaped member 41c inserted through the light guide-side through hole 48b, and rotates together with the wheel member 47 around the axis of the shaft-shaped member 41c. Around the light guide-side through hole 48b on the right plate surface of the light guide member 48, a light guide side projecting portion 48c projecting rightward is provided. The light guide side projecting portion 48c is provided in a substantially L shape when viewed from the right side so that the light guide-side through hole 48b is hidden when the light guide member 48 is viewed from above.

The torsion spring 45 has a coil spring portion 45a and a pair of urging portions 45b. The coil spring portion 45a is a coil spring, and is fixed to the spring fixing portion 47d while being wound around the outer peripheral surface of the spring fixing portion 47d. Both ends of the coil spring portion 45a extend below the spring fixing portion 47d. The pair of urging portions 45b are made of elongated cylindrical rubber members inserting the respective ends of the coil spring portion 45a therein. When the operation wheel 44 is in the initial state P0, the pair of urging portions 45b urge the first spring contact portion 47e such that the inner portions sandwich the first spring contact portion 47e while contacting the first spring contact portion 47e.

The holding member 46 is made of synthetic resin and is a member for holding the position of the torsion spring 45. The holding member 46 has a bottom portion 46a and a side plate portion 46b. The bottom portion 46a is arranged above the light source substrate 43 and is shaped so as not to cover the light emitting sides of the LEDs 43a to 43c. Both front and rear sides of the bottom portion 46a are slightly raised in a block shape, and the inner surface thereof is recessed in a curved shape along the outer peripheral surface of the operation wheel 44. The bottom portion 46a is fixed to the flat plate portion 42a of the fixing metal fitting 42 by screwing with the light source substrate 43 and the insulating plate IP sandwiched therebetween. Therefore, the holding member 46 is fixed to the inner frame 37 via the fixing metal fitting.

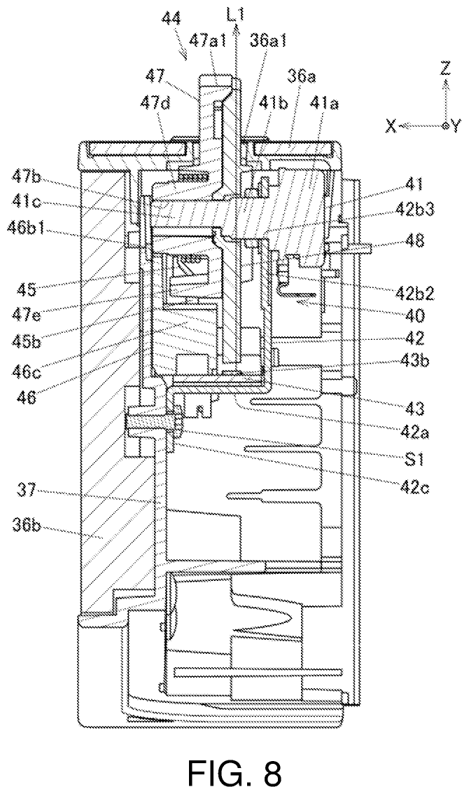

The side plate portion 46b rises in a flat plate shape from the left end portion of the bottom portion 46a to the spring fixing portion 47d of the wheel member 47 with its plate surfaces oriented in the horizontal directions. At the tip of the side plate portion 46b, a wheel receiving portion 46b1 (“supporting member”) is provided which is cut out in a substantially arc shape along the outer peripheral surface of the spring fixing portion 47d. The wheel receiving portion 46b1 is close to the spring fixing portion 47d with a small gap therebetween in the vertical direction and the horizontal direction (the directions orthogonal to the axial direction of the shaft-shaped portion 41c). Therefore, the wheel receiving portion 46b1 can support the spring fixing portion 47d when the spring fixing portion 47d is inclined downward (in a direction orthogonal to the axial direction of the shaft-shaped portion 41c). The operation wheel 44 is arranged so as to be sandwiched between the resistor fixing portion 42b2 and the wheel receiving portion 46b1 in the axial direction of the shaft-shaped portion 41c (see FIG. 8).

In addition, a portion of the right side plate surface of the side plate portion 46b located below the first spring contact portion 47e is provided with a second spring contact portion 46c that protrudes to the right in a substantially flat plate shape with its plate surfaces facing in the vertical directions. The plate surface of the second spring contact portion 46c is gently curved so as to be convex downward, and has substantially the same width as the first spring contact portion 47e. When the operation wheel 44 is in the initial state P0, the pair of urging portions 45b of the torsion spring 45 are in contact with the second spring contact portion 46c while the inner sides of the urging portions 45b sandwich the second spring contact portion 46c and urge the spring contact portion 46c at a position below the first spring contact portion 47e.

In the pitch bender 40 configured as described above, when the operation wheel 44 is rotated, the shaft-shaped member 41c of the variable resistor 41 interlocks with the operation wheel 44, and the shaft-shaped member 41c rotates around its axis. When the shaft-shaped member 41c rotates, the variable resistor 41 converts the rotation angle into an electric signal and outputs the electric signal to the first substrate 37a. The electrical signal output to the first substrate 37a side is output to a control board of the electronic keyboard instrument 10 via the first substrate 37a, and is analyzed and controlled by the control board so as to apply a pitch bend effect on musical tones of the electronic keyboard instrument 10 that corresponds to the rotation angle of the operation wheel 44.

Further, in the pitch bender 40, when the operation wheel 44 is rotated to the front side, the wheel-side projecting portion 47c sandwiches the biasing portion 45b, on the front side, of the torsion spring 45, and indirectly contacts the front side end of the second spring contact portion 46c so that the rotation of the operation wheel 44 to the front side is restricted in the first state P1 in which the operation wheel 44 is rotated 45 degrees to the front side from the initial state P0. Similarly, when the operation wheel 44 is rotated to the rear side, the wheel-side projecting portion 47c sandwiches the biasing portion 45b, on the rear side, of the torsion spring 45, and indirectly contacts the rear side end of the second spring contact portion 46c so that the rotation of the operation wheel 44 to the rear side is restricted in the second state P2 in which the operation wheel 44 is rotated 45 degrees to the rear side from the initial state P0. In addition, within the range in which the operation wheel 44 can be rotated, the light source substrate 43 and the like are not visible through the operation opening 36a1 due to the wheel-side projecting portion 47c and the light guide-side projecting portion 48c provided on the operation wheel 44.

Further, in the pitch bender 40, when the operation wheel 44 is rotated, one of the pair of urging portions 45b of the torsion spring 45 contacts the first spring contact portion 47e and is separated from the second spring contact portion 46c, and the other of the pair of urging portions 45b of the torsion spring 45 contacts the second spring contact portion 46c and is separated from the first spring contact portion 47e, thereby widening the distance between the pair of urging portions 45b. Therefore, when the operation wheel 44 is rotated from the initial state PO and a finger or the like is released from the operation recess 44a of the operation wheel 44, the elastic restoring force of the torsion spring 45 moves the operation wheel 44 to the initial state P0. That is, the position of the torsion spring 45 is held by the holding member 46 (second spring contact portion 46c).

Also, in the pitch bender 40, the light emission status of each of the LEDs 43a to 43c is controlled by the control board in accordance with the pitch bend effect imparted to the musical tone, other operation statuses, or the like. Specifically, the control board performs control to change the light emission color, light emission interval, and the like of each of the LEDs 43a to 43c. The light emitted from each of the LEDs 43a to 43c enters from the lower portion of the edge 48a of the light guide member 48, is diffused, and is guided in the light guide member 48 in its radial directions. The light guided in the light guide member 48 is emitted from the upper part of the edge 48a of the light guide member 48 so that the player can visually recognize the light (see optical path L1 shown in FIG. 8). This allows the player to know the musical tone control state of the electronic keyboard instrument 10.

Next, in the pitch bender 40, when an abnormal load is applied from the outside to a portion of the operation wheel 44 exposed from the operation opening 36a1 (hereinafter referred to as “exposed portion”), the manner in which the load is dispersed is explained. As used herein, the term “abnormal load” refers to an excessive load that cannot be applied by rotating the operation wheel 44 normally, and that is imparted due to accidental events such as sudden impact by the falling down of the electronic keyboard instrument 10.

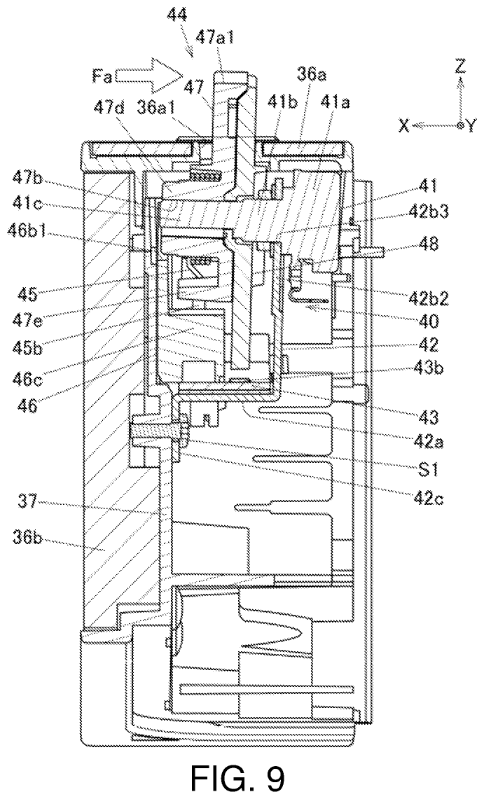

As shown in FIG. 9, when a rightward load Fa is applied to the exposed portion, the load Fa is transmitted through the operation wheel 44 to the variable resistor 41 inserted into the operation wheel 44, and the resistor fixing portion 42b2 of the fixing metal fitting 42 that fixes the variable resistor 41 bends to the right. When the resistor fixing portion 42b2 bends to the right, the operation wheel 44 tilts to the right, and the right plate surface of the light guide member 48 comes into contact with the edge of the operation opening 36a1 provided in the top panel 36a, and the bending of the resistor fixing portion 42b2 stops midway thereby. As the resistor fixing portion 42b2 bends to the right in this way, the rightward load Fa applied to the exposed portion is dispersed.

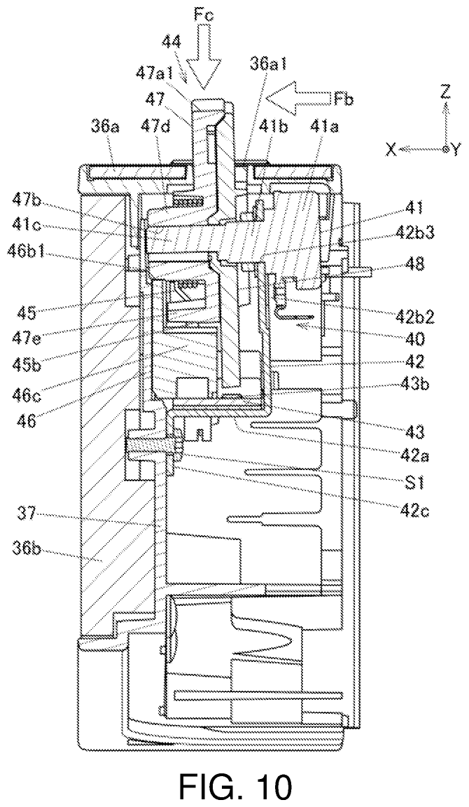

Further, as shown in FIG. 10, when a leftward load Fb is applied to the exposed portion, the load Fb is transmitted to the variable resistor 41 via the operation wheel 44, and the resistor fixing portion 42b2 of the fixing metal fitting 42 bends to the left. When the resistor fixing portion 42b2 bends leftward, the operation wheel 44 tilts leftward and the left side of the wheel member 47 comes into contact with the edge of the operation opening 36a1 provided in the upper panel 36a, and the bending of the resistor fixing portion 42b2 stops midway thereby. As the resistor fixing portion 42b2 bends leftward in this way, the leftward load Fb applied to the exposed portion is dispersed.

In the pitch bender 40, the wheel-side through hole 47b and the light guide-side through hole 48b through which the shaft-shaped member 41c of the variable resistor 41 is inserted are located on the left side of the fixing opening 42b3 (resistor fixing portion 42b2) to which the sensor rear portion 41b of the variable resistor 41 is fixed. Because of this, as shown in FIG. 10, when a downward load Fc is applied to the exposed portion, the load Fc is distributed leftward and downward, and the distributed load Fb is transmitted upon the variable resistor 41 through the operation wheel 44. As a result, the operation wheel 44 tilts downward while the resistor fixing portion 42b2 of the fixing metal fitting 42 bends to the left. When the operation wheel 44 tilts downward, the spring fixing portion 47d comes into contact with the wheel receiving portion 46b1 of the holding member 46 so that the spring fixing portion 47d is supported by the wheel receiving portion 46b1, and the bending of the resistor fixing portion 42b2 stops midway. As the resistor fixing portion 42b2 bends leftward in this manner, the downward load Fc applied to the exposed portion is dispersed.

As described above, the pitch bender 40 according to the present embodiment is fixed to the inner frame 37 of the left case 36, and includes the rotatable variable resistor 41, the operation wheel 44 that is rotatably attached to the variable resistor 41, and the fixing metal fitting 42 for fixing the variable resistor 41 to the inner frame 37. The fixing metal fitting 42 has the resistor fixing portion 42b2 that is connected to the variable resistor 41 and that has flexibility.

Since the pitch bender 40 is configured as described above, when an abnormal load is applied to a part of the operation wheel 44 from various directions, the load is applied to the variable resistor 41 to which the operation wheel 44 is attached. The load transmitted to the variable resistor 41 is transmitted to the resistor fixing portion 42b2 of the fixing metal fitting 42 to which the variable resistor 41 is connected, and the resistor fixing portion 42b2 bends according to the load. This disperses the abnormal load applied to a portion of the operating wheel 44. Therefore, it is possible to prevent the load from concentrating on the variable resistor 41 or the operation wheel 44, and it is possible to realize the pitch bender 40 in which even if an abnormal load is applied to the operation wheel 44 from the outside, the variable resistor 41 and the operation wheel 44 will not be damaged or dropped.

In the pitch bender 40, the variable resistor 41 has a shaft-shaped member 41c that can rotate around an axis, and the fixing metal fittings 42 has a pair of slits 42b1 opening upwards (in a direction perpendicular to the axial direction of the shaft-shaped member 41c) arranged on both sides of the resistor fixing portion 42b2. As a result, even if a part of the fixing metal fitting 42 (the first screwing portion 42c and the second screwing portion 42d) is fixed to the inner frame 37, flexibility in the left-right direction (the axial direction of the shaft-shaped member 41c) can be imparted to the resistor fixing portion 42b2 positioned between the pair of slits 42b1 opened upward.

Also, in the pitch bender 40, the variable resistor 41 has the shaft-shaped member 41c that can rotate around its axis, and has the holding member 46 having the wheel receiving portion 46b1 that is adjacent to the spring fixing portion 47d vertically and horizontally (in the directions orthogonal to the axial direction of the shaft-shaped member 41c) and that is capable of supporting the spring fixing portion 47d. The holding member 46 is fixed to the inner frame 37 of the left case 36 through the fixing metal fitting 42. As a result, when a load in a direction from the operation wheel 44 to the wheel receiving portion 46b1 (for example, toward the downward direction) is applied to the operation wheel 44, the operation wheel 44 tilts toward the wheel receiving portion 46b1 and the spring fixing portion 47d is supported by the wheel receiving portion 46b1. Therefore, when an abnormal load toward the wheel receiving portion 46b1 is applied to the operation wheel 44, the load is dispersed by the bending of the resistor fixing portion 42b2, and then the bending of the resistor fixing portion 42b2 stops halfway. This prevents the operation wheel 44 from tilting excessively.

Further, in the pitch bender 40, the operation wheel 44 is sandwiched between the resistor fixing portion 42b2 and the wheel receiving portion 46b1 in the axial direction of the shaft-shaped member 41c. As a result, a configuration is provided such that when an abnormal load is applied to the operation wheel 44 in a direction away from the resistor fixing portion 42b2, that is, in a direction from the operation wheel 44 toward the wheel receiving portion 46b1, the spring fixing portion 47d is supported by the wheel receiving portion 46b1.

Also, the electronic keyboard instrument 10 according to this embodiment includes a pitch bender 40 and the case 30. As a result, even if the electronic keyboard instrument 10 falls over and an abnormal load is applied to the operation wheel 44, the load is dispersed by bending the resistor fixing portion 42b2. Therefore, it is possible to realize the electronic keyboard instrument 10 in which the pitch bender 40 is less likely to be damaged.

Also, in the electronic keyboard instrument 10, the pitch bender 40 is housed in the left case 36, and the left case 36 has the upper panel 36a provided with the operation opening 36a1 through which a portion of the pitch bender 40 is exposed. As a result, when the operation wheel 44 is tilted by a load in a predetermined direction (rightward load in this embodiment), a portion of the operation wheel 44 is brought into contact with an edge of the operation opening portion 36a1 provided on the upper panel 36a, and the deflection of the resistor fixing portion 42b2 stops halfway. Therefore, it is possible to prevent the operation wheel 44 from being excessively tilted.

In addition, in the electronic keyboard instrument 10, the left case 36 has the inner frame 37 to which the fixing metal fitting 42 is fixed on the inner surface side in which the pitch bender 40 is housed. As a result, it is possible to realize the electronic keyboard instrument 10 in which the pitch bender 40 is less likely to be damaged when the pitch bender 40 is housed and fixed inside the left case 36.

It should be noted that the embodiments described above are presented as examples and are not intended to limit the scope of the invention. These novel embodiments can be implemented in various other forms, and various omissions, replacements, and modifications can be made without departing from the spirit of the invention. These embodiments and their modifications are included in the scope and gist of the invention, and are included in the scope of the invention described in the claims and its equivalents. For example, in the above embodiments, the pitch bender was exemplified as the manipulator, but other manipulators such as a modulation wheel may be used. Further, for example, in the above-described embodiments, an electronic keyboard instrument is used as an example of an electronic musical instrument, but other electronic musical instruments that do not have a keyboard may be used.

What is claimed is:

1. A manipulator, comprising:
a case;
an axis-having member having a rotatable member;
an operation member attached to the rotatable member of the axis-having member so as to be rotatable together with the rotatable member; and
a fixing member that fixes the axis-having member to the case, the fixing member having a flexible member that is attached to the axis-having member.

2. The manipulator according to claim 1,
wherein the rotatable member is a shaft-shaped member that is rotatable around an axis, and
wherein the fixing member has a pair of slits each opening in a direction perpendicular to a direction of said axis, thereby defining the flexible member in between.

3. The manipulator according to claim 1,
wherein the rotatable member is a shaft-shaped member that is rotatable around an axis, and
wherein the manipulator further comprises a supporting member fixed to the case, the supporting member being adjacent to, and capable of supporting, a part of the operation member in a direction perpendicular to a direction of said axis.

4. The manipulator according to claim 2,
wherein the rotatable member is a shaft-shaped member that is rotatable around an axis, and
wherein the manipulator further comprises a supporting member fixed to the case, the supporting member being adjacent to, and capable of supporting, a part of the operation member in a direction perpendicular to a direction of said axis.

5. The manipulator according to claim 3, wherein the operation member is sandwiched between the flexible member and the supporting member in a direction of said axis.

6. The manipulator according to claim 4, wherein the operation member is sandwiched between the flexible member and the supporting member in a direction of said axis.

7. An electronic musical instrument, comprising:
the manipulator as set forth in claim 1; and
a control board connected to the manipulator and causing electronically synthesized sound to be generated and output.

8. The electronic musical instrument according to claim 7,
wherein the operation member is housed in the case, and
wherein the case has a panel member having an opening from which a part of the operation member is exposed.

9. The electronic musical instrument according to claim 8, wherein the case includes a frame member to which the fixing member is fixed in an inside of the case in which the operation member is housed.

10. An electronic musical instrument, comprising:
the manipulator as set forth in claim 2; and
a control board connected to the manipulator and causing electronically synthesized sound to be generated and output.

11. The electronic musical instrument according to claim 10,
wherein the operation member is housed in the case, and
wherein the case has a panel member having an opening from which a part of the operation member is exposed.

12. The electronic musical instrument according to claim 11, wherein the case includes a frame member to which the fixing member is fixed in an inside of the case in which the operation member is housed.

13. An electronic musical instrument, comprising:
the manipulator as set forth in claim 3; and
a control board connected to the manipulator and causing electronically synthesized sound to be generated and output.

14. The electronic musical instrument according to claim 13,
wherein the operation member is housed in the case, and
wherein the case has a panel member having an opening from which a part of the operation member is exposed.

15. The electronic musical instrument according to claim 14, wherein the case includes a frame member to which the fixing member is fixed in an inside of the case in which the operation member is housed.

16. An electronic musical instrument, comprising:
the manipulator as set forth in claim 4; and
a control board connected to the manipulator and causing electronically synthesized sound to be generated and output.

17. The electronic musical instrument according to claim 16,
wherein the operation member is housed in the case, and
wherein the case has a panel member having an opening from which a part of the operation member is exposed.

18. The electronic musical instrument according to claim 17, wherein the case includes a frame member to which the fixing member is fixed in an inside of the case in which the operation member is housed.
